(19) United States
(12) Patent Application Publication
(10) Pub. No.: US 2009/0319947 A1
(43) Pub. Date: Dec. 24, 2009

(54) MOBILE COMMUNICATION DEVICE WITH GRAPHICAL USER INTERFACE TO ENABLE ACCESS TO PORTAL SERVICES

(75) Inventors: Xinlei Wang, Shanghai (CN); Mei Zhao, Beijing (CN); Melora Zaner-Godsey, Shanghai (CN); Ou Li, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,820

(22) Filed: Jun. 22, 2008

(51) Int. Cl. G06F 3/048

(52) U.S. Cl. 715/810

(57) ABSTRACT

Systems, methods, and devices for accessing portal services via a mobile communication device are provided. The mobile communication device may execute a menu program having a graphical user interface. The graphical user interface may include a service menu screen including a plurality of service selectors, each service selector having a respective service icon positioned within a boundary, the service icon graphically representing a service of a communications portal with which the mobile communication device is configured to communicate. Each respective service icon may be selectable by a user to access a corresponding client program of the associated service served by the communications portal. At least some of the service selectors may further include a shared status icon indicating an operational state of the service and/or associated client program.

### BACKGROUND

Mobile communication devices, such as Internet-enabled mobile telephones, have become increasingly popular in recent years. In some countries, they represent the primary device that most users utilize to access information online. Another trend in modern computing is that users increasingly store information in multiple locations, such as at an online portal site, a desktop computer, and a mobile communication device. While mobile communication devices can offer convenient access to information when a user is traveling, one drawback of such devices is that they have a screen and keypad that are small compared to desktop devices, and therefore space on the graphical user interface of such devices is at a premium. In particular, as applications and services for mobile devices grow increasingly feature rich, they can become more difficult to use. This may present a barrier to users accessing services at online portal websites via mobile communication devices.

### SUMMARY

Systems, methods, and devices for accessing portal services via a mobile communication device are provided. The mobile communication device may execute a menu program having a graphical user interface. The graphical user interface may include a service menu screen including a plurality of service selectors, each service selector having a respective service icon positioned within a boundary, the service icon graphically representing a service of a communications portal with which the mobile communication device is configured to communicate. Each respective service icon may be selectable by a user to access a corresponding client program of the associated service served by the communications portal. At least some of the service selectors may further include a shared status icon indicating an operational state of the service and/or associated client program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an embodiment of a portal system for mobile communications, the system including a communications portal with a plurality of portal services and a mobile communication device with graphical user interface of a menu program that enables access to the portal services.

FIG. 2 is a schematic diagram illustrating a menu hierarchy of the system of FIG. 1.

FIG. 3 is a schematic diagram illustrating a desktop share interface of a service client program executed on the mobile communication device of the system of FIG. 1.

FIG. 4 is a schematic diagram illustrating a service summary screen of a menu program executed on the mobile communication device of the system of FIG. 1.

FIG. 5 is a flowchart of an embodiment of a method for accessing portal services from a mobile communication device via a graphical user interface.

### DETAILED DESCRIPTION

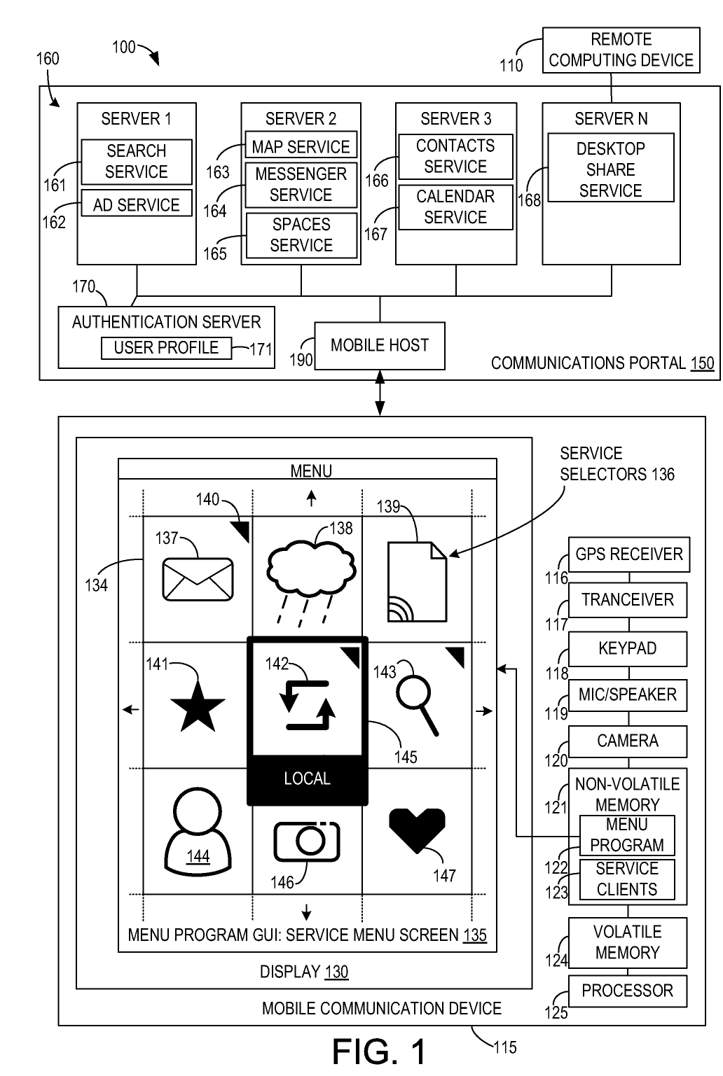

FIG. 1 illustrates a mobile communications system 100, including a mobile communication device 115 configured to communicate with a communications portal 150. The communications portal 150 may, for example, be the Microsoft® Windows® Live portal, or other suitable portal configured to verify a user identification via an authentication server 170, and offer the user access via a login account to a variety of services executed on servers 160 associated with the communications portal 150. User settings may be saved in a user profile 171 stored at a location accessible to the authentication server 170, or at another suitable location. The communications portal may include a mobile host 190 configured to establish remote communications with mobile communication device 115.

It will be appreciated that the mobile communication device 115 may be a web enabled telephone or other suitable portable communications device, and may be configured to communicate with mobile host 190 over any of several networks using various cellular protocols, including code division multiple access (CDMA), time division multiple access (TDMA), global system for mobile communications (GSM), evolution-data optimized protocol (EV-DO), or other suitable mobile communications protocols. Additionally, mobile communication device 115 may use wireless or wired networking protocols, paging protocols, etc.

In an example embodiment, servers 160 may include a server 1 with a search service 161 and an advertising service 162; server 2 with a map service 163, messenger service 164, and a spaces service 165; server 3 with a contacts service 166 and a calendar service 167; and server N with a desktop share service 168, wherein server N is in communication with a remote computing device 110.

The mobile communication device 115 comprising a processor 125 and associated volatile memory 124 and non-volatile memory 121. The mobile communication device 115 may further include a camera 120, keypad 118, microphone and speaker 119, display 130, transceiver 117 for communicating with the network of mobile host 190, and a global positing system receiver, or GPS receiver 116, for ascertaining a geographic location of the mobile communication device 115 from satellite signals.

The mobile communication device 115 may be configured to execute a menu program 122 in a graphical user interface, such as service menu screen 135 including a plurality of service selectors 136. Each service selector may include a respective service icon, such as message icon 137, positioned within a boundary 134, the service icon graphically representing a service of a communications portal 150 with which the mobile communication device 115 is configured to communicate. For example, the message icon 137 may represent the messenger service 164 in communications portal 150. Each respective service icon is selectable by a user to access a corresponding client program of the associated service served by the communications portal 150.

In an example embodiment, a menu program may provide a service menu screen 135 containing service icons including a message icon 137 to indicate if there are any messages in a user's account and to provide a link to a message service; a weather icon 138 linked to a weather service, for example to display the current weather in a user specified location; an RSS feed icon 139 to provide syndications from user specified web-pages, news feeds, or other services. Further, service icons may include a share folder icon 141 linking to a spaces service for a user to send content the user wants to share to a favorite folder, a blog, etc.; a local icon 142 to further provide a map or connected services related to the users location or storing location specific information, such as the Microsoft® Windows® Live service; a search icon 143 linking to a search service. The example embodiment in FIG. 1 further includes service icons comprising a contacts icon 144 linking to a contacts service to provide information such as an address book, contact information, etc.; a camera icon 146 to operate a camera, view pictures, etc.; and other icons 147 that may link to services suitable for accessing through service menu screen 135 in a mobile communications device 115.

At least some of the service selectors further include a shared status icon 140 indicating an operational state of the service and/or associated client program. The status icon 140 may represent, for example, that a client program of the service is currently being executed on the mobile communication device. The operational state may also indicate, for example, that content available from the service has been updated, that new content is available from the service, or that a new version of the service client is available.

The graphical user interface may further include a respective text label positioned adjacent to each service icon. It will be appreciated that a preferences interface may be provided and that a color of each icon and associated text label, a font of each text label, and a style of each icon may be selectable by a user via the preferences interface.

The service icon may be of virtually any suitable form. For example, a drawing or other graphic may be used. Or, the service icon may be a preview of a screen of a graphical user interface of a client program for an associated service.

The plurality of service selectors may be arranged in a grid, and the boundaries of the selectors may be formed along lines of the grid.

The grid may be scrollable both vertically and horizontally within the service menu screen 135 of the graphical user interface.

Each selector may be configured to be browsed by a user, for example by the user clicking once with a finger or stylus on the selector or using an input device. In response, the service menu screen 135 may be configured to display a highlight graphic 145 positioned around the boundary of the browsed menu item. The highlight graphic 145 may be configured to present additional information to the user related to the service.

It will be appreciated that the user may freely add and delete selectors 136 from the service menu screen, according to the user's preferences. The identity of the selectors that are included in a user's service menu screen may be communicated to each of the associated services. Based on this information, these services may be configured to exchange cross-service data with each other, either through the mobile communications device, or directly. This cross-service data may be used by each service to generate a customized user experience for the user. The mobile communication device may be configured to present the customized user experience via a client program of each service based on the cross-service data exchanged between services.

The cross-service data, for example, may be user specific settings for each service, such as GPS data, permissions settings, peer lists, etc. Although all of the services are illustrated in FIG. 1 as belonging to communications portal 150, it will be appreciated that one or more of the services may be resident at a different communications portal. Thus, services from different communications portals that are represented by service selectors 136 may be configured for cross-service communication of user-specific data, via the mobile communication device, or directly. This cross-service communication of data may be leveraged by each service to present an appropriately tailored user experience to each user.

As one example of cross-service data sharing, the map service may be aware of a photo service in the system, and may be configured to send GPS meta data to the photo service. The photo service, in turn, may be able to tag photos that are taken with the GPS meta data, or may be configured to search for similar photos based on the GPS meta data, for example.

As another example of cross-service data sharing, the messenger service may be configured to communicate permissions assigned in the messenger service to a new peer of the user to the calendar service, and the calendar service can then determine whether or not to allow the new peer access to information in the user's calendar.

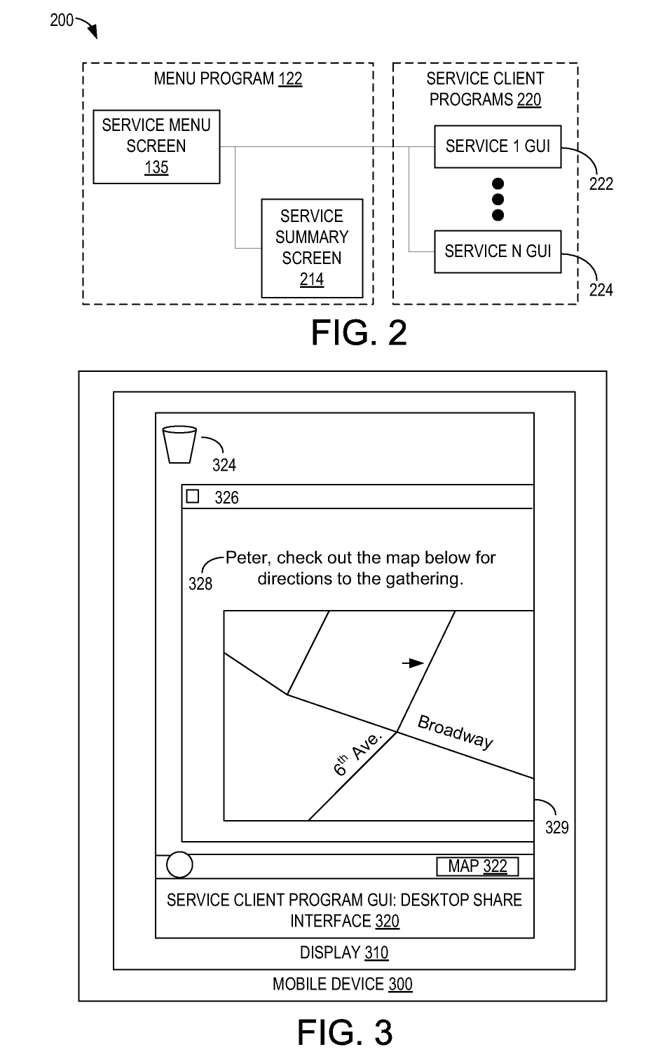

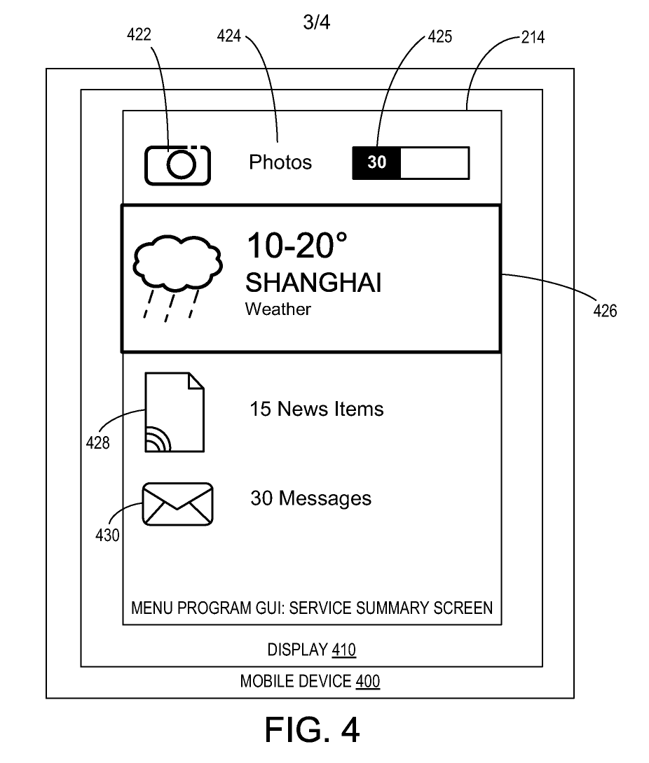

FIG. 2 illustrates a menu hierarchy 200 of the system of FIG. 1. Specifically, it will be appreciated that the menu program 122 is configured to display a service menu screen 135, as illustrated in FIG. 1, as well as a service summary screen 214, as depicted in FIG. 4 below. In addition, upon selection of one of the service selectors 136 of the service menu screen 135, the menu program 122 is configured to cause a service client 123 to be executed on the mobile communication device 115, which in turn connects to the associated service of the communications portal 150. In the illustrated example, service client programs 220 may include multiple GUIs including a first service GUI 222 up to an Nth service GUI 224. In the present embodiment, the service client programs 210 correspond to the services provided by servers 160 in FIG. 1, however, other embodiments are not so limited and other services may be included, a subset of the services on servers 160 may be included, or a user selectable set of services may be included, etc.

Turning now to FIG. 3, in one use scenario a user selection of one of the service selectors 136 in the service menu screen 135 of FIG. 1 may correspond to the desktop share service, and the desktop share service may be configured to display a real-time image 329 of a desktop of a remote computing device 110 on the display 310 of a mobile device 300, via a desktop share interface 320, as illustrated in FIG. 3. In one embodiment, mobile device 300 may be mobile communication device 115.

In FIG. 3, mobile device 300 displays a real-time image from a desktop of a remote computing device 110 including a map graphic, a comment block including text 328, a window 326, a map button 322 and a recycle bin 324. It will be appreciated that the desktop of a remote computing device 110 may be a different size than the display of the mobile device 300. In an example where the remote computing device has a larger desktop than the mobile device 300, the desktop share interface 320 may be scrollable and/or zoomable by the user, to enable a user to navigate to a desired portion of the desktop of the remote computing device. As an example, window 326 may include a map that continues beyond the right side of desktop share interface 320. By using scrolling functionality in desktop share interface 320, a user may scroll to view a portion of the desktop of the remote computing device 110 that is not currently displayed in display 310.

As shown in FIG. 4, mobile device 400 includes a display 410 to provide a graphical user interface including a service summary screen 214. In one embodiment, the service summary screen 214 may further include a plurality of user configurable entries, where each entry may include an icon, a text label, a summary of downloadable data, etc., from each respective one of the services in service menu screen 135. In the illustrated example, a camera service 422 is indicated as having 30 photos 424. Service summary screen 214 further includes a weather service 426 that includes a cloud icon and text stating it is a weather service including weather information for Shanghai, China; an RSS Feed service 428 is illustrated including 15 new items for a user to download; and a messenger service 430 is illustrated having 30 messages.

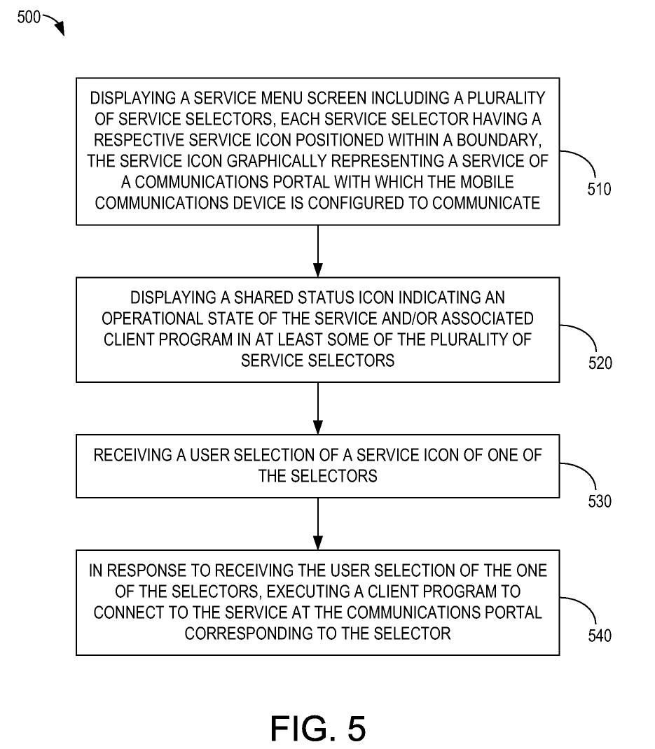

Turning now to FIG. 5, a method 500 of accessing one or more services of a communications portal from a mobile communication device is illustrated. At 510, the method may include displaying a service menu screen including a plurality of service selectors, each service selector having a respective service icon positioned within a boundary, the service icon graphically representing a service of a communications portal with which the mobile communication device is configured to communicate. At 520, the method may include displaying a shared status icon indicating an operational state of the service and/or associated client program in at least some of the plurality of service selectors. At 530, the method may include receiving a user selection of a service icon of one of the selectors. At 540, the method may include, in response to receiving the user selection of the one of the selectors, executing a client program to connect to the service at the communications portal corresponding to the selector.

It will be appreciated that the services may be selected from the group consisting of a search service 161, an advertising service 162, a map service 163, a messenger service 164, a spaces service 165, a contacts service 166, a calendar service 167, and a desktop share service 168, as discussed above. In the case where the user selection corresponds to the desktop share service 168, the desktop share service 168 is configured to display a real-time image of a desktop of a remote computing device 110 on the display of the mobile communication device 115, as discussed above.

Further, the desktop of the remote computing device may be larger than the display of the mobile communication device, and in such case the desktop share interface may be scrollable and/or zoomable by the user, to enable the user to navigate to a desired portion of the desktop of the remote computing device.

The appearance and layout of the graphical user interface may be as illustrated and described above. Thus, it will be appreciated that the status icon may represent that a client program of the service is currently being executed on the mobile communication device. Further, the plurality of service selectors may be arranged in a grid, and the boundaries of the selectors may be formed along lines of the grid. The grid may be scrollable both vertically and horizontally within the service menu screen of the graphical user interface, to enable a user easy access to the various selectors.

The above described systems and methods may be utilized to provide a user with seamless access to one or more services at a communications portal from a mobile communication device. The graphical user interface described above presents a plurality of selectors, each of which includes both a service icon representing the service itself, and a status icon conveying information related to the state of the service and/or a client program associated with the service. In this manner a user may quickly ascertain which services the user desires to use, saving time and communication costs. Further, features of the specific services that may be accessed by such an interface, such as the remote desktop share, offer increased flexibility for communications between users and peers.

It will be appreciated that the embodiments described herein may be implemented, for example, via computer-executable instructions or code, such as programs, stored on computer-readable storage media and executed by a computing device, such as a processor of server computing subsystem, for example. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, personal computers, servers, laptop computers, hand-held devices, microprocessor-based programmable consumer electronics and/or appliances, etc. The mobile communication device described herein may, for example, be a hand held device, such as a web-enabled mobile telephone, personal digital assistant, music player, or mini-computer, for example.

It will be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A mobile communication device configured to execute a menu program having a graphical user interface, the graphical user interface comprising:
a service menu screen including a plurality of service selectors, each service selector having a respective service icon positioned within a boundary, the service icon graphically representing a service of a communications portal with which the mobile communication device is configured to communicate;
wherein each respective service icon is selectable by a user to access a corresponding client program of an associated service served by the communications portal; and
wherein at least some of the service selectors further include a shared status icon indicating an operational state of the service and/or an associated client program.

2. The mobile communication device of claim 1, wherein the status icon represents that a client program of the service is currently being executed on the mobile communication device, that content available from the service has been updated, that new content is available from the service, or that a new version of the service client is available.

3. The mobile communication device of claim 2, further comprising a respective text label positioned adjacent each service icon;
wherein a color of each icon and associated text label, a font of each text label, and a style of each icon is selectable by a user.

4. The mobile communication device of claim 1, wherein the service icon includes a preview of a screen of a graphical user interface of the client program of the service.

5. The mobile communication device of claim 1, wherein the plurality of service selectors are arranged in a grid, and boundaries of the service selectors are formed along lines of the grid.

6. The mobile communication device of claim 5, wherein the grid is scrollable both vertically and horizontally within the service menu screen of the graphical user interface.

7. The mobile communication device of claim 6, wherein each service selector is configured to be browsed by a user; and
wherein the service menu screen further comprises a highlight graphic positioned around a boundary of a browsed menu item.

8. The mobile communication device of claim 1,
wherein an identity of the service selectors that are included in the service menu screen are communicated to each of the associated services, to enable the services to exchange cross-service data with each other, either through the mobile communications device, or directly; and
wherein the mobile communication device is configured to present a customized user experience via a client program of each service based on the cross-service data exchanged between services.

9. The mobile communication device of claim 1, wherein each service is selected from a group consisting of a search service, an advertising service, a map service, a messenger service, a spaces service, a contacts service, a calendar service, and a desktop share service.

10. The mobile communication device of claim 9, wherein a user selection corresponds to the desktop share service; and
wherein the desktop share service is configured to display a real-time image of a desktop of a remote computing device on a display of the mobile communication device.

11. The mobile communication device of claim 10, wherein the desktop of the remote computing device is larger than the display of the mobile communication device; and
wherein the desktop share interface is scrollable and/or zoomable by a user, to enable the user to navigate to a desired portion of the desktop of the remote computing device.

12. The mobile communication device of claim 1, wherein the graphical user interface further comprises:
a service summary screen including a plurality of user configurable entries, each entry including an icon and/or text label, and a summary of downloaded data from each respective service.

13. A mobile communication device configured to execute a menu program having a graphical user interface, the graphical user interface comprising:
a service menu screen including a plurality of service selectors, each service selector having a respective service icon positioned within a boundary, the service icon graphically representing a service of a communications portal with which the mobile communication device is configured to communicate;
wherein each respective service icon is selectable by a user to access a corresponding client program of an associated service served by the communications portal; and
wherein one service is a desktop share service configured to display a real-time image of a desktop of a remote computing device in a desktop share interface on a display of the mobile communication device.

14. The mobile communication device of claim 13, wherein the desktop of the remote computing device is larger than the display of the mobile communication device; and
wherein the desktop share interface is scrollable and/or zoomable by a user, to enable the user to navigate to a desired portion of the desktop of the remote computing device.

15. A method of accessing one or more services of a communications portal from a mobile communication device, the method comprising:
displaying a service menu screen including a plurality of service selectors, each service selector having a respective service icon positioned within a boundary, the service icon graphically representing a service of a communications portal with which the mobile communication device is configured to communicate;
displaying a shared status icon indicating an operational state of the service and/or associated client program in at least some of the plurality of service selectors;
receiving a user selection of a service icon of one of the service selectors; and
in response to receiving the user selection of the one of the service selectors, executing a client program to connect to the service at the communications portal corresponding to the service selector.

16. The method of claim 15, wherein services are selected from a group consisting of a search service, an advertising service, a map service, a messenger service, a spaces service, a contacts service, a calendar service, and a desktop share service.

17. The method of claim 16, wherein a user selection corresponds to the desktop share service; and
wherein the desktop share service is configured to display a real-time image of a desktop of a remote computing device in a desktop share interface on a display of the mobile communication device.

18. The method of claim 17, wherein the desktop of the remote computing device is larger than the display of the mobile communication device; and
wherein the desktop share interface is scrollable and/or zoomable by a user, to enable the user to navigate to a desired portion of the desktop of the remote computing device.

19. The method of claim 15, wherein the status icon represents that a client program of the service is currently being executed on the mobile communication device, that content available from the service has been updated, that new content is available from the service, or that a new version of the service client is available.

20. The method of claim 19, wherein the plurality of service selectors are arranged in a grid, and boundaries of the service selectors are formed along lines of the grid; and
wherein the grid is scrollable both vertically and horizontally within the service menu screen of the graphical user interface.
